(19) United States
(12) Patent Application Publication
(10) Pub. No.: US 2006/0142914 A1
(43) Pub. Date: Jun. 29, 2006

(54) Vehicle data recording system with detachable recording apparatus

(75) Inventor: Nobuhiro Yokogawa, Toyota-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/303,983

(22) Filed: Dec. 19, 2005

(30) Foreign Application Priority Data
Dec. 27, 2004 (JP) 2004-376652

(51) Int. Cl. G01C 21/36

(52) U.S. Cl. 701/35; 701/200

(57) ABSTRACT

A system for recording, in a recording apparatus, data transmitted from a plurality of nodes provided on board a vehicle includes an in-vehicle communication line to which the nodes are connected, and a connector configured to be connected to the in-vehicle communication line and to be detachably connectable to the recording apparatus, the connector serving to link the recording apparatus to the nodes via the in-vehicle communication line.

### BACKGROUND OF THE INVENTION

1. Field of the Invention

The present invention generally relates to data recording systems, and particularly relates to a data recording system suitable to record data in a recording apparatus as data is supplied from a plurality of nodes provided on board a vehicle.

2. Description of the Related Art

Conventionally, systems for failure diagnosis following a vehicle accident are known. These systems record data in a recording apparatus as data is output from a plurality of nodes connected via an in-vehicle LAN (e.g., see Patent Document 1). In such systems, after a start of the vehicle, a plurality of nodes such as an engine controller, an ABS controller, and a door controller transmit data to the in-vehicle LAN periodically for provision to the recording apparatus, and the recording apparatus records the transmitted data. The data recorded in the recording apparatus are later used to analyze the behavior of the vehicle and/or the driver's driving operations at the time of an accident.

[Patent Document 1] Japanese Patent Application No. 2002-330149

In the conventional systems as described above, the recording apparatus is implemented at the gateway that connects the in-vehicle LAN segments together, and, thus, is fixedly mounted on the vehicle at the time of manufacturing the vehicle. With this configuration, however, the recording capacity of the recording apparatus cannot be flexibly changed, which may result in only an insufficient amount of data being stored in the recording apparatus. Further, with the recording apparatus fixedly mounted on the vehicle, there may be an inconvenient situation in which collecting and recovering the data stored in the recording apparatus may require excessive efforts and lengthy time.

Accordingly, there is a need for a data recording system in which the recording apparatus for recording vehicle data is detachable from the vehicle, thereby capable of flexibly coping with various needs regarding the recording apparatus.

### SUMMARY OF THE INVENTION

It is a general object of the present invention to provide a data recording system that substantially obviates one or more problems caused by the limitations and disadvantages of the related art.

It is another and more specific object of the present invention to provide a data recording system in which the recording apparatus for recording vehicle data is detachable from the vehicle, thereby capable of flexibly coping with various needs regarding the recording apparatus.

To achieve these and other objects and advantages in accordance with the purpose of the invention, the invention provides a system for recording, in a recording apparatus, data transmitted from a plurality of nodes provided on board a vehicle, the system including an in-vehicle communication line to which the nodes are connected, and a connector configured to be connected to the in-vehicle communication line and to be detachably connectable to the recording apparatus, the connector serving to link the recording apparatus to the nodes via the in-vehicle communication line.

According to at least one embodiment of the present invention, the recording apparatus for recording data transmitted from the plurality of nodes is detachably connectable to the connector so as to be linked to the nodes. In the state of being connected to the connector, the recording apparatus acquires data from the nodes via the in-vehicle communication line. With this provision, it is possible to detach the recording apparatus from the vehicle and to flexibly cope with various needs such as a need to exchange the recording apparatus to another recording apparatus having a larger recording capacity.

In this configuration, the recording apparatus records data as the data is transmitted from the nodes to the in-vehicle communication line.

Further, the recording apparatus includes a search-purpose data generating unit configured to generate additional data that is to be paired with the data transmitted from the nodes, and the recording apparatus records the data transmitted from the nodes in such a manner that the transmitted data is paired with the additional data generated at the time that the recording apparatus receives the transmitted data. With this provision, the additional data is entered (e.g., as query data) to promptly find or locate data desired for analysis at the time of analyzing data recorded in the recording apparatus.

In this configuration, the additional data may be indicative of current position of the vehicle, or may be indicative of time.

At least one embodiment of the present invention can thus provide a data recording system in which the recording apparatus for recording vehicle data is detachable from the vehicle, thereby capable of flexibly coping with various needs regarding the recording apparatus.

### BRIEF DESCRIPTION OF THE DRAWINGS

Other objects and further features of the present invention will be apparent from the following detailed description when read in conjunction with the accompanying drawings; in which:

FIG. 1 is a drawing showing the configuration of a data recording system provided on board a vehicle according to one embodiment of the present invention; and

FIG. 2 is a drawing showing the configuration of a data recording system provided on board a vehicle according to a variation of the embodiment of the present invention

### DESCRIPTION OF THE PREFERRED EMBODIMENTS

In the following, embodiments of the present invention will be described with reference to the accompanying drawings.

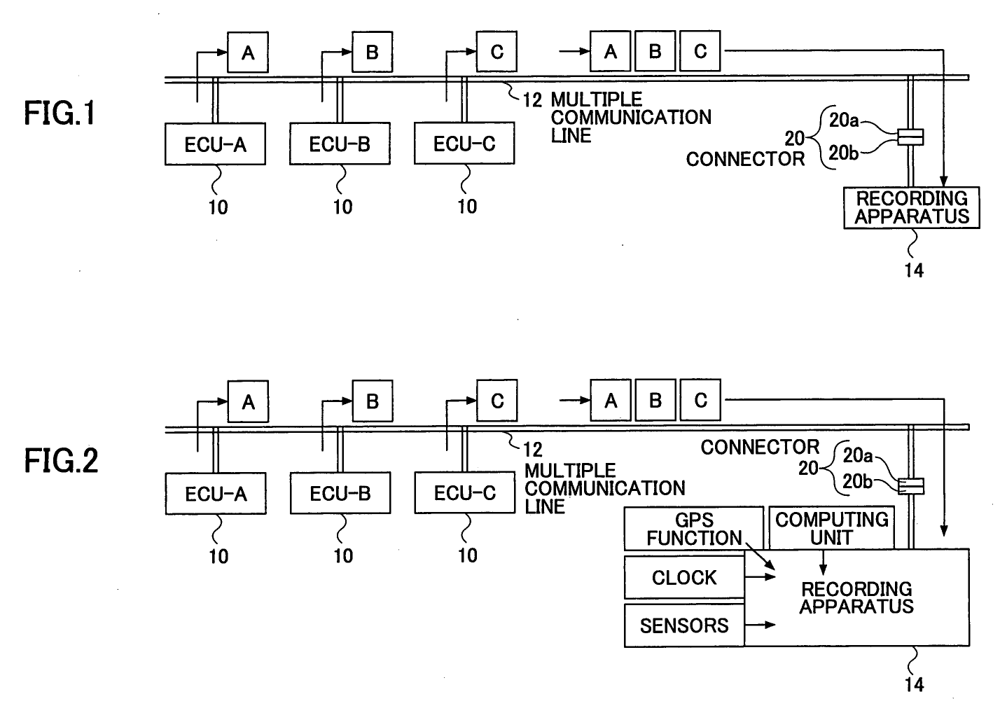

FIG. 1 is a drawing showing the configuration of a data recording system provided on board a vehicle according to one embodiment of the present invention. The system of this embodiment includes a plurality of nodes 10 (three nodes in this example), a multiple communication line 12 providing couplings between the nodes 10, and a recording apparatus 14 connectable to the multiple communication line 12. This system serves to collect data in the recording apparatus 14 as the data is transmitted from the nodes 10 to the recording apparatus 14 via the multiple communication line 12. In the following, the three nodes 10 coupled to the multiple communication line 12 are referred to as ECU-A, ECU-B, and ECU-C as appropriate, and it is presumed that the data of all the nodes 10 is recorded in the recording apparatus 14. However, other nodes 10 for which data is not recorded in the recording apparatus 14 may as well be coupled to the multiple communication line 12.

The multiple communication line 12 is a shared bus comprised of a single line or twisted paired lines such as CAN (Controller Area Network), and provides for the data output from the nodes 10 to be transmitted through time-division multiplexing (multiplexed communication) according to a predetermined communication protocol. Data transmitted from a node 10 is sent to another node 10 or to the recording apparatus 14 via the multiple communication line 12.

The nodes 10 include an intelligent sensor and an ECU that is an electronic control unit comprised mainly of a computer provided for each type of controller provided in the vehicle. Examples of such nodes 10 include a ruder angle sensor for outputting a signal responsive to a steering rudder angle, a yaw rate sensor for outputting a signal responsive to a yaw rate generated around the center-of-gravity axis of a vehicle, an engine ECU for controlling an engine based on the gate opening of a throttle, the gate opening of an accelerator, the temperature of engine water, etc., a VSC-ECU (Vehicle Stability Control-ECU) for stabilizing the rotational movement of the vehicle in response to the speed of wheels, a yaw rate, a steering rudder angle, etc., a transmission ECU for controlling a shift position of the vehicle in response to the position of a shift operation or the like, a break ECU for controlling the breaking power of the vehicle in response to a foot pressure on the break pedal, a steering rudder angle, etc., a power steering ECU for controlling a steering assist power in response to a steering rudder angle and the like, and an auto-air-conditioning ECU for controlling air-conditioning in the vehicle in response to the switches for operating air-conditioning, temperature inside the vehicle, etc.

Each of the nodes 10 periodically transmits data to the recording apparatus 14 via the multiple communication line 12 where the data needs to be recorded in the recording apparatus 14 for the purpose of diagnosing a vehicle failure. Such period may be 500 ms, for example, and may differ from node to node. Each of the nodes 10 includes a microcomputer having a controller embedded therein, and further includes a communication module coupled to the microcomputer. The microcomputer controls the controller according a common communication protocol used in the network that is comprised of the multiple communication line 12 and the nodes 10, and digitizes output data to be output therefrom for transmission to the recording apparatus 14 or another node 10 via the multiple communication line 12. The communication module is controlled by the controller to transmit the data converted by the microcomputer to the recording apparatus 14 or another node 10 via the multiple communication line 12.

A node 10 not only performs local control according to the conditions of the sensor and switches connected thereto, but also performs local control according to data transmitted from another node 10 via the multiple communication line 12. In such a case, the communication module receives data that is transmitted from a remote node 10 to the local node 10, and the microcomputer decodes the data from the remote node 10 received by the communication module via the multiple communication line 12, thereby performing local control.

Data transmitted from each node 10 is defined as a data frame having a predetermined configuration. The data frame includes a start-of-frame (SOF) indicative of the start of the frame, a field indicative of an identification ID for discriminating data types (also indicating the level of priority regarding the transmission of data at the time of collision of data transmitted from a plurality of nodes 10), a data-length code (DLC) indicative of the length of the data, a field containing the data contents (e.g., data indicative of wheel speed, a value indicative of control instruction regarding a drive torque, etc.), a CRC field for checking transmission error, a field for confirming a normal completion of reception, and an end-of-frame (EOF) indicative of the end of the frame.

The system of this embodiment also includes connectors 20 connected to the multiple communication line 12. The connectors 20 serve to couple the recording apparatus 14 to the multiple communication line 12 so as to link the recording apparatus 14 with the nodes 10 via the multiple communication line 12. The connectors 20 includes a first connector 20a provided at an end of the multiple communication line 12 on the vehicle side at such a position as to be easily accessible by hand by an operator or vehicle occupant from outside, and also includes a second connector 20b attached on the recording apparatus side (specifically, at an end of the input lines connected to the recording apparatus 14). The second connector 20b has such shape as to fittingly engage the first connector 20a. The recording apparatus 14 is configured such as to be detachable from the network that is comprised of the multiple communication line 12 and the nodes 10. When the first connector 20a is engaged with the second connector 20b through manual operation by an operator or vehicle occupant, the recording apparatus 14 is connected to the multiple communication line 12. Upon disengagement, the recording apparatus 14 is disconnected from the multiple communication line 12.

Like each of the nodes 10 described above, the recording apparatus 14 includes a microcomputer having a controller embedded therein, and a communication module connected to the microcomputer. The recording apparatus 14 further includes a temporal storage data table and a nonvolatile recording medium such as a hard-disk. The microcomputer is programmed so as to record data in the nonvolatile recording medium via the temporal storage data table after the data is transmitted from the nodes ECU-A, ECU-B, and ECU-C and received by the communication module. In the state of being linked to the multiple communication line 12 via the connectors 20, the recording apparatus 14 controls the controller according to the common communication protocol used in the network, so that the communication module receives data transmitted from the nodes 10 to the multiple communication line 12, followed by the recording of the data in the recording apparatus 14. Specifically, the data transmitted from the nodes 10 is temporarily stored in the temporal storage data table, and, then, the data stored in the temporal storage data table is stored in the nonvolatile recording medium at constant intervals.

In the following, a description will be given of a method of recording data in the recording apparatus 14 when the data necessary to be stored in the recording apparatus 14 is transmitted from the nodes 10 to the multiple communication line 12.

As shown in FIG. 1, for example, the node ECU-A of this embodiment has data (e.g., vehicle speed) that needs to be recorded in the recording apparatus 14. This data has a frame ID “A” assigned thereto. The node ECU-B has data (e.g., engine rotation speed) that needs to be recorded in the recording apparatus 14. This data has a frame ID “B” assigned thereto. The node ECU-C has data (e.g., a yaw rate) that needs to be recorded in the recording apparatus 14. This data has a frame ID “C” assigned thereto. ECU-A, ECU-B, and ECU-C set data necessary to be recorded in the recording apparatus 14 in a data frame having the frame ID assigned to the data type of this date, and transmit the data frame to the multiple communication line 12 at predetermined intervals. When time comes for data necessary to be recorded in the recording apparatus 14 to be transmitted to the multiple communication line 12, ECU-A, for example, sets the data in the data frame having the frame ID “A” that is assigned beforehand to the data type of this data, followed by transmitting the data frame to the multiple communication line 12.

When the driver of the vehicle or the like feels the possibility of a vehicle failure or when the owner of the vehicle purchases the vehicle, the driver, owner, or an operator who analyzes vehicle failures engages the second connector 20b with the first connector 20a so as to connect the recording apparatus 14 to the network of the multiple communication line 12. In this engaged condition, the recording apparatus 14 reads the frame ID of a data frame transmitted from a node 10 to the multiple communication line 12, and receives the data when determining that the data frame is directed to the recording apparatus 14 according to the frame ID. In the recording apparatus 14, data of all the frame IDs necessary to be recorded are recorded in the temporal storage data table separately on a frame-ID-specific basis. Upon receiving the above-noted data, the recording apparatus 14 updates (overwrites) data for the frame ID “A” with the received data. In so doing, data for other frame IDs stored in the temporal storage data table are maintained without updating.

Separately from the data updating process of updating data in the temporal storage data table, the recording apparatus 14 copies the data of all the frame IDs stored in the temporal storage data table at constant internals (e.g., once a second) together in a lump, thereby storing these data in the nonvolatile recording medium. This copying and storing of data at constant intervals is always performed even if none of the data of all the frame IDs has been updated in the temporal storage data table. In the nonvolatile recording medium, all the data that have been copied and stored from the temporal storage data table during a predetermined preceding period are stored in such a manner that these data are paired with additional data such as vehicle position and the time at which each data is detected. Such additional data is detected by a particular node 10 (e.g., a navigation apparatus) connected to the multiple communication line 12, and is transmitted from this node 10 to the recording apparatus 14 via the multiple communication line 12. This transmission may be performed by use of a search-purpose data frame that is different from a recording-purpose routine data frame.

The order of data items transmitted to the multiple communication line 12 may be as follows: data of the frame ID “A” provided by ECU-A (data content: A1), data of the frame ID “B” provided by ECU-B (data content: B1), data of the frame ID “A” provided by ECU-A (data content: A2), and data of the frame ID “C” provided by ECU-C (data content: C1). In this case, the recording apparatus 14 receives these data items in this order.

In such a case, each time the recording apparatus 14 receives data from one of ECU-A through ECU-C, the recording apparatus 14 updates (overwrites) data of the corresponding frame for storage of the received data. When receiving the data of the frame ID “A” provided by ECU-A (data content: A1), the recording apparatus 14 updates data of the frame ID “A” in the temporal storage data table with the data “A1”. When receiving the data of the frame ID “A” (data content: A2) subsequently, the recording apparatus 14 updates the data “A1” with the data “A2”. When receiving the data of the frame ID “B” provided by ECU-B (data content: B1), the recording apparatus 14 updates data of the frame ID “B” in the temporal storage data table with the data “B1”.

Further, after updating the data of the frame ID “A” with the data “A1” in the temporal storage data table, time may come for the recording apparatus 14 to perform copying of data to the nonvolatile recording medium. When such time comes, the recording apparatus 14 copies the data of all the frame IDs in the temporal storage data table together in a lump to store all the data in the nonvolatile recording medium. Thereafter, the data of the frame ID “B” in the temporal storage data table may be updated with the data “B1”, and, then, time may come for the recording apparatus 14 to perform copying of data to the nonvolatile recording medium. When such time comes, the recording apparatus 14 copies the data of all the frame IDs in the temporal storage data table together in a lump to store all the data in the nonvolatile recording medium. After this storing operation, time may come again for the recording apparatus 14 to perform copying of data to the nonvolatile recording medium while no data has been received from any node 10 and thus no data update has been performed in the temporal storage data table since the last storing operation. Nonetheless, when such time comes, the recording apparatus 14 copies the then-existing data of all the frame IDs in the temporal storage data table together in a lump to store all the data in the nonvolatile recording medium. Thereafter, the data of all the frame IDs in the temporal storage data table are copied together in a lump to store all the data in the nonvolatile recording medium again and again at constant intervals.

The data collected and stored in the nonvolatile recording medium of the recording apparatus 14 as described above are later used to analyze the behavior of the vehicle and the driver's driving operations for the purpose of diagnosing a vehicle failure. For example, the operator performing the analysis utilizes the search-purpose additional data paired with the collected data so as to search for time stamps recorded in the nonvolatile recording medium, thereby identifying the date and time of the vehicle failure. Also, the operator may identify vehicle conditions at the time of vehicle failure by checking the vehicle speed and/or yaw rate.

According to the system of this embodiment described above, a plurality of types of data belonging to the nodes 10 have unique frame IDs assigned thereto on a data-type-specific basis in the network in which the nodes 10 and the recording apparatus 14 are connected via the multiple communication line 12. Data are transmitted from the nodes 10 to the recording apparatus 14 via the multiple communication line 12, and the recording apparatus 14 records the data separately for each frame ID. The data recorded in this manner forms separate lumps, each of which includes a plurality of types of data collected generally at the same time period. With this provision, this embodiment makes it possible to utilize various data recorded in the recording apparatus 14 so as to diagnose a vehicle failure and analyze the conditions of the vehicle and the driver's driving operations at the time of the failure.

The recording apparatus 14 records the data necessary to be recorded provided from each of the nodes 10, and, also, records additional data such as the data indicative of the relevant time and vehicle position. With the system of this embodiment, therefore, when there is a need to conduct an analysis by use of the data stored in the recording apparatus 14, additional data may be entered as a query to extract (find or locate) the data to be analyzed promptly. Conversely, the relevant time, vehicle position, and so on can be obtained from the data to be analyzed.

In the configuration described above, in order to record data in the recording apparatus 14, it suffices for each node 10 to set data in a data frame having a data-type-specific frame ID for transmission to the multiple communication line 12, and it suffices for the recording apparatus 14 to sort the received data according to the frame IDs. There is no need for the recording apparatus 14 to identify a data-originating node 10. According to this embodiment, therefore, there is no need to define a set of original rules for use between the recording apparatus 14 and the nodes 10 for the purpose of recording a plurality of types of data in the recording apparatus 14, and the common existing rules can properly be used. This makes it possible to reduce the cost and work load associated with the development of the nodes 10 and recording apparatus 14, thereby allowing a general-purpose, simple data recording system to be implemented.

In the data recording system according to this embodiment, further, the recording apparatus 14 is connectable to the multiple communication line 12 via the connectors 20, and is configured to be detachable from the network comprised of the multiple communication line 12 and the plurality of nodes 10. The connecting and disconnecting of the recording apparatus 14 is performed by the driver, owner, or analyst of the vehicle by engaging or disengaging the second connector 20b with the first connector 20a.

In such configuration, the shape of the second connector 20b and the shape of the first connector 20a that match each other and have the predetermined functions as described above suffice for the purpose of coupling various types of recording apparatus 14 to the in-vehicle network comprised of the nodes 10 and the multiple communication line 12, thereby allowing the mounting and exchanging of the recording apparatus 14 connectable to the in-vehicle network to be easily performed. Because of this, the recording apparatus 14 may be replaced with one having a larger recording capacity if there is a need to increase a recording capacity to record data for a longer time period. In this manner, flexible measures can be taken according to various user needs.

If the recording apparatus 14 is fixedly mounted to the network without any detachable capability, such a system would make it difficult to modify application software for implementing the above-described functions of the recording apparatus 14. AS a result, the recording apparatus 14 may only be able to record a predetermined set of data types. In contrast, the configuration of the present embodiment allows the recording apparatus 14 to be detached from the in-vehicle network. This provision makes it possible to easily modify the application software of the recording apparatus 14. Thus, flexible measures can be taken according to data types to be collected when the data types to be collected needs to be changed such as when there is a need to stop collecting data from a particular node 10 and to increase a data recording time for another node 10.

In the present embodiment, a person who wishes to record vehicle data needs to mount the recording apparatus 14 to the in-vehicle network. A person who does not wish to record vehicle data, on the other hand, does not have to mount the recording apparatus 14 to the in-vehicle network. In this regard, there is no need to install the recording apparatus 14 to the in-vehicle network from the time when the vehicle is put up for sale. This reduces word load of vehicle assembly, and reduces the number of assembly components to achieve a cost reduction.

Further, as described above, the recording apparatus 14 is configured to be detachable from the network that is comprised of the multiple communication line 12 and the nodes 10. If the recording apparatus 14 is fixedly mounted to and not detachable from the network, there is a need to bring an analyzer close to the vehicle in which the recording apparatus 14 is installed, and to connect the analyzer to the recording apparatus 14 or to the multiple communication line 12 via a LAN cable or the like for communication for the purpose of collecting recorded data. According to the configuration of the present embodiment, the recording apparatus 14 having data recorded therein is detached from the in-vehicle network, and the recorded data of the recording apparatus 14 can be collected at another cite. This reduces work load and manual labor associated with the analysis of data.

The multiple communication line 12 described in the embodiment may properly be referred to as an in-vehicle communication line.

In the embodiment described above, data necessary for the diagnosis of vehicle failure is recorded in the recording apparatus 14 in such a manner as to be linked with the additional data such as the time of data detection and the vehicle position at the time of the data detection. The additional data is detected by a particular node 10 connected to the multiple communication line 12, and is transmitted via the multiple communication line 12 to the recording apparatus 14 for recordation therein. Alternatively, as shown in FIG. 2, the function (inclusive of a computing unit) to detect the time and vehicle position indicative of various conditions as the search-purpose additional data may be installed in the detachable recording apparatus 14. Further, a function (inclusive of a vibration detector) to detect a sensor detection value such as vehicle vibration data that is not transmitted through the multiple communication line 12 may as well be installed in the detachable recording apparatus 14.

With the configuration as described above, even if the nodes 10 connected to the network do not detect the search-purpose additional data, or dot not transmitted the search-purpose additional data after detection thereof, data necessary to be recorded can be recorded in the recording apparatus 14 in such as manner as to be paired with the additional data. As a result, it becomes possible to extract desired vehicle data reliably by use of the additional data at the time of vehicle diagnosis. Further, since this configuration eliminates a need to provide the function to detect the additional data in the vehicle, it is possible to reduce vehicle costs and the number of steps for vehicle assemblage.

Further, the present invention is not limited to these embodiments, but various variations and modifications may be made without departing from the scope of the present invention.

The present application is based on Japanese priority application No. 2004-376652 filed on Dec. 27, 2004, with the Japanese Patent Office, the entire contents of which are hereby incorporated by reference.

What is claimed is:

1. A system for recording, in a recording apparatus, data transmitted from a plurality of nodes provided on board a vehicle, comprising:
an in-vehicle communication line to which the nodes are connected; and
a connector configured to be connected to said in-vehicle communication line and to be detachably connectable to the recording apparatus, said connector serving to link the recording apparatus to the nodes via said in-vehicle communication line.

2. The system as claimed in claim 1, wherein the recording apparatus records data as the data is transmitted from the nodes to the in-vehicle communication line.

3. The system as claimed in claim 1, further comprising said recording apparatus, wherein said recording apparatus includes a search-purpose data generating unit configured to generate additional data that is to be paired with the data transmitted from the nodes, and said recording apparatus records the data transmitted from the nodes in such a manner that the transmitted data is paired with the additional data generated at the time that the recording apparatus receives the transmitted data.

4. The system as claimed in claim 3, wherein the additional data is indicative of current position of the vehicle.

5. The system as claimed in claim 3, wherein the additional data is indicative of time.
